(19) United States
(12) Patent Application Publication
(10) Pub. No.: US 2025/0117650 A1
(43) Pub. Date: Apr. 10, 2025

(54) COMPILER-BASED DEEP LEARNING MODEL PRUNING APPARATUS AND METHOD

(71) Applicant: Electronics and Telecommunications Research Institute, Daejeon (KR)

(72) Inventors: Yong-In Kwon, Daejeon (KR); Je-Min Lee, Daejeon (KR)

(73) Assignee: Electronics and Telecommunications Research Institute, Daejeon (KR)

(21) Appl. No.: 18/612,169

(22) Filed: Mar. 21, 2024

(30) Foreign Application Priority Data
Oct. 5, 2023 (KR) 10-2023-0132558

(51) Int. Cl. G06N 3/08

(52) U.S. Cl. CPC G06N 3/08

(57) ABSTRACT

Disclosed herein are a compiler-based deep learning model pruning apparatus and method. The compiler-based deep learning model pruning method includes extracting multiple subgraphs from a first deep learning model, generating programs representing respective tasks allocated to the extracted multiple subgraphs, compiling the first deep learning model based on selected programs and measuring execution times of tasks of the first deep learning model on respective devices, and creating a second deep learning model by pruning a subgraph corresponding to at least one task selected from among the tasks from the first deep learning model based on the execution times on the respective devices.

### CROSS REFERENCE TO RELATED APPLICATION

This application claims the benefit of Korean Patent Application No. 10-2023-0132558, filed Oct. 5, 2023, which is hereby incorporated by reference in its entirety into this application.

### BACKGROUND OF THE INVENTION

### 1. Technical Field

The following embodiments relate to deep learning model lightweight technology.

### 2. Description of the Related Art

A deep learning model is gradually and widely used in various application fields such as image processing and speech recognition. Because such a deep learning model is composed of numerous complex neural networks, a lot of computation is required for executing the deep learning model.

Recently, an offloading method using a cloud has been widely used to execute such a deep learning model on a resource-constrained mobile device. However, because this off-roading method is limited due to network overhead and interruption that often occur, there is a need to execute the deep learning model directly on the mobile device. In addition, performing deep learning inference on the mobile device may be more advantageous in terms of user convenience and privacy protection.

Accordingly, various methods have been used to improve deep learning inference directly run on the mobile device, and are roughly divided into two methods, that is, a method for creating a light deep learning model using model compression and a method for creating optimized code for a target device using a deep learning compiler.

Of these methods, model compression is to optimize a neural network using a method, for example, pruning, quantization, or a neural architecture search (NAS). In particular, model pruning is a method for reducing the model size by removing neurons which are unimportant in the deep learning model or which are redundant. Further, quantization is a method for reducing the model size by decreasing the precision of data. Furthermore, NAS is a method for optimizing the structure of the deep learning model to maximize performance.

On the other hand, a deep learning compiler creates optimized executable code for each target device.

Meanwhile, it may be considered that, after model compression and compiler optimization are independently performed, integrating the results of performance can create code most efficient for a specific target device. However, in reality, this may not always be the case. That is, the reason for this is that there are many cases where the fastest deep learning model satisfying required accuracy through pruning is not an optimal model after compiler optimization.

### SUMMARY OF THE INVENTION

An embodiment is intended to create a pruning model suitable for a target device, which meets accuracy requirements by utilizing compiler information such as subgraph structures and execution times of a neural network on the target device rather than independently performing deep learning compression and compiler optimization.

In accordance with an aspect, there is provided a compiler-based deep learning model pruning method, including extracting multiple subgraphs from a first deep learning model, generating programs representing respective tasks allocated to the extracted multiple subgraphs, compiling the first deep learning model based on selected programs and measuring execution times of tasks of the first deep learning model on respective devices, and creating a second deep learning model by pruning a subgraph corresponding to at least one task selected from among the tasks from the first deep learning model based on the execution times on the respective devices.

Generating the programs may include allocating an identical task to two or more subgraphs having an identical form.

The compiler-based deep learning model pruning method may further include short-term training the compiled first deep learning model and thereafter measuring accuracy of the first deep learning model, and determining whether the accuracy of the first deep learning model and an execution time of the first deep learning model meet certain criteria, wherein, when it is determined that the accuracy of the first deep learning model and the execution time of the first deep learning model meet the certain criteria, proceeding to creating the second deep learning model.

The first deep learning model may be selected from among multiple candidate deep learning models, and when it is determined that the execution time of the first deep learning model does not meet a certain criterion, the first deep learning model is changed to one of the multiple candidate deep learning models, and thereafter a procedure starting from extracting subgraphs from the changed first deep learning model is performed again.

The compiler-based deep learning model pruning method may further include sequentially aligning the tasks based on the execution times between the measuring and creating the second deep learning model.

The aligning may include updating a first table in which a program executed at a highest speed for each task, an execution time of the program executed at the highest speed, a number of subgraphs, and a total execution time for each task calculated by multiplying the execution time of the corresponding program by the number of subgraphs are mapped to each task, and aligning the tasks in descending order based on total execution times for respective tasks and storing the aligned tasks in a task list.

The compiler-based deep learning model pruning method may further include updating a second table in which at least one subgraph allocated to each task and a fastest program are mapped to each task, between the aligning and creating the second deep learning model, wherein the pruning may include creating at least one second deep learning model by pruning a selected subgraph while maintaining a fastest program for an at least one high-ranked task selected from among the aligned tasks.

The compiler-based deep learning model pruning method may further include updating the multiple candidate deep learning models to at least one second deep learning model, and selecting one of updated multiple candidate deep learning models as a first deep learning model, and repeatedly performing again a procedure starting from extracting subgraphs from the first deep learning model, wherein the procedure is repeatedly performed until the execution time of the first deep learning model meets a certain criterion and a task to be pruned is not present in a previously updated task list.

In accordance with another aspect, there is provided a compiler-based deep learning model pruning apparatus, including memory configured to store at least one program, and a processor configured to execute a first program, wherein the first program may perform extracting multiple subgraphs from a first deep learning model, creating second programs representing respective tasks allocated to the extracted multiple subgraphs, compiling the first deep learning model based on selected second programs and measuring execution times of tasks of the first deep learning model on respective tasks, and creating a second deep learning model by pruning a subgraph corresponding to at least task selected from among the tasks from the first deep learning model based on the execution times on the respective devices.

In generating the second programs, the first program may allocate an identical task to two or more subgraphs having an identical form.

The first program may further perform short-term training the compiled first deep learning model and thereafter measuring accuracy of the first deep learning model, and determining whether the accuracy of the first deep learning model and an execution time of the first deep learning model meet certain criteria, when it is determined that the accuracy of the first deep learning model and the execution time of the first deep learning model meet the certain criteria, the first program performs creating the second deep learning model.

The first deep learning model may be selected from among multiple candidate deep learning models, and the first program may further perform, when it is determined that the execution time of the first deep learning model does not meet a certain criterion, changing the first deep learning model to one of the multiple candidate deep learning models, and thereafter performing again a procedure starting from extracting subgraphs from the changed first deep learning model.

The first program may further perform sequentially aligning the tasks based on execution times between the measuring and creating the second deep learning model.

The first program may further perform, in aligning, updating a first table in which a second program executed at a highest speed for each task, an execution time of the second program executed at the highest speed, a number of subgraphs, and a total execution time for each task calculated by multiplying the execution time of the corresponding second program by the number of subgraphs are mapped to each task, and aligning the tasks in descending order based on total execution times for respective tasks and then storing the aligned task in a task list.

The first program may further perform updating a second table in which at least one subgraph allocated to each task and a fastest second program are mapped to each task, between the aligning and creating the second deep learning model, in pruning, the first program creates at least one second deep learning model by pruning a selected subgraph while maintaining a fastest second program for an at least one high-ranked task selected from among the aligned tasks.

The second program may perform updating the multiple candidate deep learning models to at least one second deep learning model, and selecting one of updated multiple candidate deep learning models as a first deep learning model, and repeatedly performing again a procedure starting from extracting subgraphs from the first deep learning model, the procedure is repeatedly performed until the execution time of the first deep learning model meets a certain criterion and a task to be pruned is not present in a previously updated task list.

In accordance with a further aspect, there is provided a compiler-based deep learning model pruning method, including extracting multiple subgraphs from a first deep learning model selected from among multiple candidate deep learning models, generating programs representing respective tasks allocated to the extracted multiple subgraphs, compiling the first deep learning model based on selected programs and measuring execution times of tasks of the first deep learning model on respective tasks, short-term training the compiled first deep learning model and thereafter measuring accuracy of the first deep learning model, and determining whether the accuracy of the first deep learning model and an execution time of the first deep learning model measured in compiling the first deep learning model meet certain criteria, sequentially aligning the tasks based on the execution times, and creating at least one second deep learning model by pruning a selected subgraph while maintaining a fastest second program for at least one high-ranked task selected from among the aligned tasks, wherein the multiple candidate deep learning models are updated to at least one second deep learning model, one of the updated multiple candidate deep learning models is selected as a first deep learning model, and a procedure starting from extracting subgraphs from the first deep learning model is repeatedly performed again, and the procedure is repeatedly performed until the execution time of the first deep learning model meets a certain criterion and a task to be pruned is not present.

The aligning may include updating a first table in which a program executed at a highest speed for each task, an execution time of the program executed at the highest speed, a number of subgraphs, and a total execution time for each task calculated by multiplying the execution time of the corresponding program by the number of subgraphs are mapped to each task, and aligning the tasks in descending order based on total execution times for respective tasks and storing the aligned tasks in a task list.

The compiler-based deep learning model pruning method may further include updating a second table in which at least one subgraph allocated to each task and a fastest program are mapped to each task, between the aligning and creating the second deep learning model.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a flowchart for explaining a compiler-based deep learning model pruning method according to an embodiment;

FIG. 2 is a diagram for explaining an example of the step of extracting multiple subgraphs in a first deep learning model according to an embodiment;

FIG. 3 is a diagram for explaining an example of the step of generating programs representing respective tasks according to an embodiment;

FIG. 4 is a diagram illustrating an example of a first table and task alignment according to an embodiment;

FIG. 5 is a diagram illustrating an example of a second table according to an embodiment;

FIG. 6 is a diagram for explaining an example of pruning of a first deep learning model according to an embodiment;

FIG. 7 is a diagram illustrating the configuration of a computer system according to an embodiment; and

FIG. 8 is a diagram illustrating an example of a program code executed in a compiler-based deep learning model pruning apparatus according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

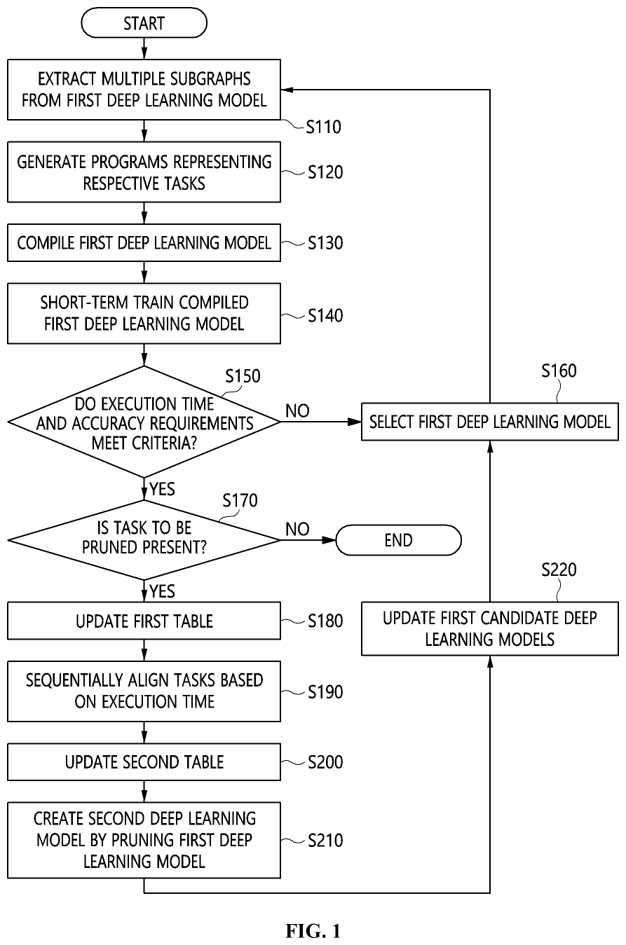

FIG. 1 is a flowchart for explaining a compiler-based deep learning model pruning method according to an embodiment.

Referring to FIG. 1, the compiler-based deep learning model pruning method according to the embodiment may include step S110 of extracting multiple subgraphs from a first deep learning model, step S120 of generating programs representing respective tasks allocated to the extracted multiple subgraphs, step S130 of compiling the first deep learning model based on selected programs and measuring the execution times of the tasks of the first deep learning model on respective devices, and step S210 of creating a second deep learning model by pruning, from the first deep learning model, a subgraph corresponding to at least one task selected from among the tasks based on the execution times on the devices.

Here, at step S110 of extracting the multiple subgraphs from the first deep learning model according to the embodiment, subgraphs in which a certain number of nodes are connected to each other through edges may be extracted from the first deep learning model.

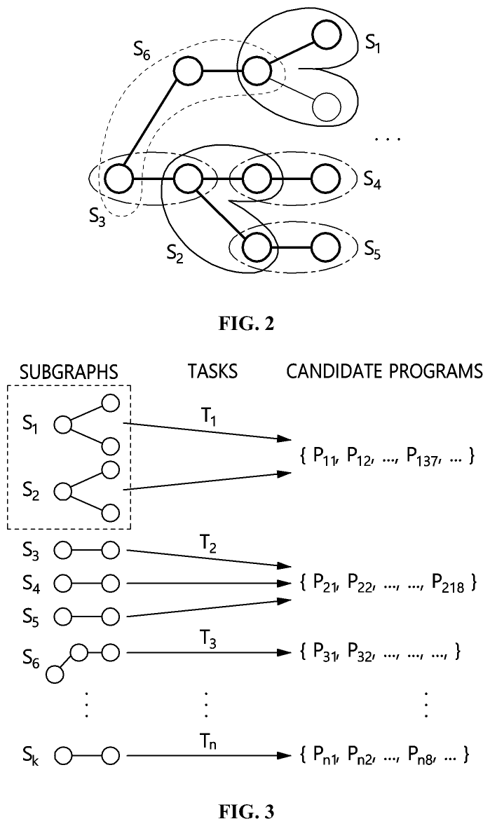

FIG. 2 is a diagram for explaining an example of the step of extracting multiple subgraphs from a first deep learning model according to an embodiment.

That is, as illustrated in FIG. 2, subgraphs S₁ to S₆ may be extracted from the first deep learning model.

Here, the first deep learning model may be composed of multiple convolutional layers and may be selected from among multiple pre-trained candidate deep learning models.

Further, at step S120 of generating the programs according to an embodiment, the same task may be allocated to two or more subgraphs having the same form.

FIG. 3 is a diagram for explaining an example of the step of generating programs representing respective tasks according to an embodiment.

For example, as illustrated in FIG. 3, subgraphs S₁ and S₂ have the same form, so that the same task T₁ is allocated to the subgraphs S₁ and S₂. Since Subgraphs S₃ to S₅ have the same form, the same task T₂ may be allocated to the subgraphs S₃ to S₅. That is, the subgraphs of the first deep learning model may be analyzed, and thus the relationships between the subgraphs and the tasks may be created.

That is, each of tasks T₁ to Tₙ may be represented by various program codes. For example, as shown in FIG. 3, the task T₁ may be represented by P₁₁, P₁₂, . . . , P₁₃₇.

Meanwhile, referring back to FIG. 1, the compiler-based deep learning model pruning method according to the embodiment may further include step S140 of short-term training the compiled first deep learning model.

That is, the inference accuracy of the compiled first deep learning model may be deteriorated. In order to improve such inference accuracy to a certain level, the first deep learning model may be trained with prepared training data for a preset period, thus improving the accuracy of the first deep learning model.

Thereafter, the compiler-based deep learning model pruning method according to the embodiment may further include step S150 of measuring the accuracy of the short-term trained first deep learning model and determining whether the accuracy of the short-term trained first deep learning model and the execution time of the first deep learning model measured at first deep learning model compiling step S130 meet predetermined criteria.

That is, at step S150, whether the following Equation (1) and Equation (2) are satisfied may be determined.

$${l}_{m} < {l}_{t} \qquad ( 1 )$$

In Equation (1), lₘ may be the measured execution time of the first deep learning model, and lₜ may be required execution time.

$${a}_{s} \geq α \cdot {a}_{p} \qquad ( 2 )$$

In Equation (2), aₛ may be measured short-term accuracy, aₚ may be required short-term accuracy, and α may be a rate indicating the minimum allowable accuracy after pruning.

Here, when the execution time and accuracy do not meet the certain criteria, that is, when Lₘ≥lₜ and aₛ<α·aₚ are satisfied, contrary to Equation (1) and Equation (2), the first deep learning model may be changed to one of the multiple candidate deep learning models at step S160, after which the process may return to step S110 of extracting subgraphs.

That is, as described above, the first deep learning model used at step S110 is selected from among the multiple candidate deep learning models, and it is determined that the execution time and the accuracy do not meet the certain criteria at step S150. Therefore, even if pruning is performed later, it is difficult to create an excellent deep learning model having good performance. Accordingly, another deep learning model among the multiple candidate deep learning models is changed to the first deep learning model, and a procedure starting from step S110 is performed again.

On the other hand, when it is determined at step S150 that the execution time and the accuracy meet the certain criteria, the process may proceed to the creating step S210.

Here, referring to FIG. 1, the compiler-based deep learning model pruning method according to the embodiment may further include steps S180 and S190 of sequentially aligning the tasks based on execution times between step the measuring S130 and step S210 of creating the second deep learning model.

Here, the alignment steps S180 and S190 may include step S180 of updating a first table in which a program executed at the highest speed for each task, the execution time of the program executed at the highest speed, the number of subgraphs, and the total execution time for each task calculated by multiplying the execution time of the corresponding program by the number of subgraphs are mapped to each task.

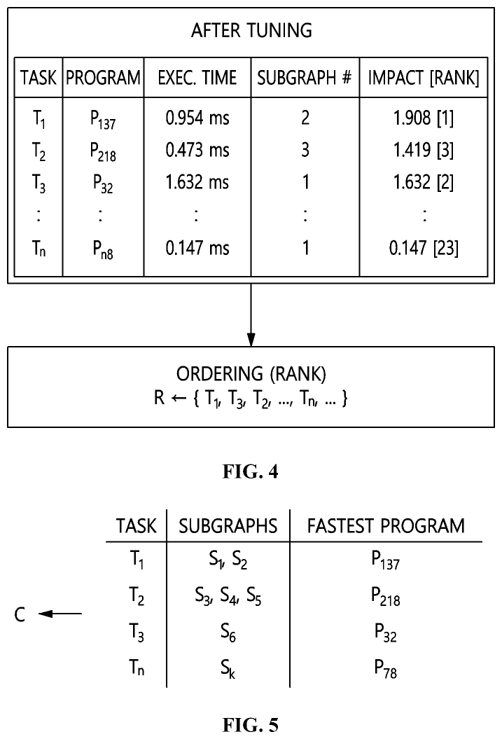

FIG. 4 is a diagram illustrating an example of a first table and a task list according to an embodiment.

For example, referring to FIG. 4, in the first table, programs (PROGRAM) P₁₃₇, . . . , Pₙ₈ executed at the maximum speed, the execution times (EXEC. TIME) 0.954 ms, . . . , 0.147 ms of the programs executed at the maximum speed, the number of subgraphs (SUBGRAPH #) 2, . . . , 1, and the total execution times (IMPACT [RANK]) 1.908, . . . , 0.147 are described as being mapped to tasks T₁, . . . , Tₙ, respectively.

Therefore, at alignment step S190, based on the pieces of data in the first table, the tasks may be aligned (reordered) in descending order based on the total execution times of respective tasks. For example, as illustrated in FIG. 4, the tasks may be sequentially aligned in the order of T₁ having the longest total execution time of 1.908 to T₃.

Here, the aligned results may be updated to a separate task list R.

Meanwhile, referring back to FIG. 1, the compiler-based deep learning model pruning method according to the embodiment may further include step S200 of updating the second table task in which at least one subgraph allocated to each task and the fastest program are mapped to each task, between the alignment step S190 and step S210 of creating the second deep learning model.

FIG. 5 is a diagram illustrating an example of a second table according to an embodiment.

Referring to FIG. 5, in a second table C, subgraphs (SUBGRAPHS) and programs executed at the highest speeds (FASTEST PROGRAM) P₁₃₇, . . . , P₁ₙ₈ are described as being mapped to tasks (TASK) T₁, . . . , Tₙ, respectively.

Therefore, at pruning step S210 according to the embodiment, at least one second deep learning model may be created by pruning a selected subgraph while maintaining the fastest program for at least one higher-ranked task selected from among the aligned tasks.

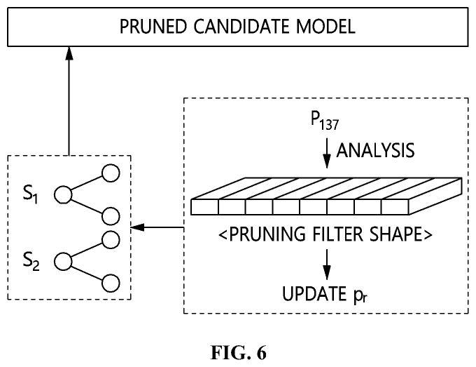

FIG. 6 is a diagram for explaining an example of pruning of a first deep learning model according to an embodiment.

As illustrated in FIG. 6, at pruning step S210, the number of filters to be pruned is determined by analyzing the filter array of each program, and a second deep learning model, which is a pruned candidate model obtained by pruning the first deep learning model using the filters of subgraphs, is created.

Here, when the number of filters to be pruned is determined, the number of filters may be defined based on a pruning rate pᵣ which is set based on the result of program analysis.

Referring back to FIG. 1, the compiler-based deep learning model pruning method according to the embodiment may update the multiple first candidate deep learning models to at least one second deep learning model at step S220, may select one of the updated multiple candidate deep learning models as the first deep learning model at step S160, and may repeatedly perform again a procedure starting from step S110 of extracting subgraphs.

This repetition may be performed until the execution time of the first deep learning model meets a certain criterion at step S150 and a task to be pruned is not present in the previously updated task list R at step S170. By means of this, the deep learning model may be gradually and repeatedly pruned, and thus an optimally lightweight second deep learning model may be created.

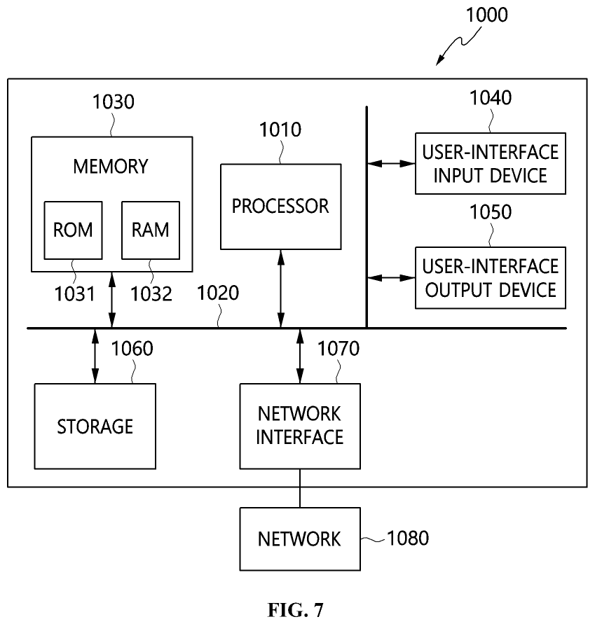

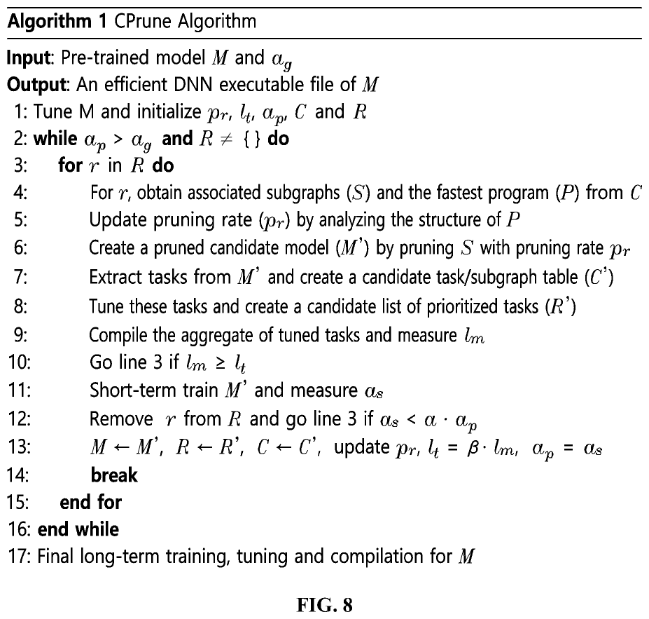

FIG. 7 is a diagram illustrating the configuration of a computer system according to an embodiment, and FIG. 8 is a diagram illustrating an example of a program code executed in a compiler-based deep learning model pruning apparatus according to an embodiment.

The compiler-based deep learning model pruning apparatus according to the embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

Here, the program executed by the processor 1010 of the compiler-based deep learning model pruning apparatus according to the embodiment may be a program code that is capable of performing the compiler-based deep learning model pruning method described above with reference to FIGS. 1 to 6.

FIG. 8 is a program illustrating a program code executed by the compiler-based deep learning model pruning apparatus according to an embodiment.

That is, as illustrated in the detailed algorithm of FIG. 8, the deep learning model is gradually and repeatedly pruned. In each iteration, the subgraphs of the model are analyzed, and relationships between the subgraphs and respective tasks are created. Thereafter, a pre-trained model M and the minimum accuracy requirement a_{g} are loaded, and then an efficient deep-learning executable code is returned in consideration of a target device.

In a first row of FIG. 8, related parameters such as a pruning rate pᵣ, a target execution time lₜ in next iteration, and short-term accuracy aₚ of a previous best model may be initialized. Further, a task/subgraph table C is initialized, and thus a task list R in which the relationships and tuning between tasks, subgraphs, and fastest programs are prioritized is stored.

Further, in second to sixteenth rows of FIG. 8, a pruning candidate model is created in each pruning iteration, and the process proceeds to an intermediate representation (IR) and tuning step. When tasks are selected in the order of R, subgraphs and the fastest program for the corresponding task are extracted from C. By analyzing the filter array of each program, the number of filters to be pruned is determined, and the filters of the subgraphs are pruned to create a pruned candidate model M′.

A task/subgraph table C′ is created by utilizing the relationships between the subgraphs of the created model M′ and respective tasks. Furthermore, the fastest program of each task is added to C′. In addition, the IR and tuning process maintain the task candidate list R′ in which priority for a next iteration is designated. When the measured execution time lₘ of M′ is shorter than lₜ, M′ is short-term trained and the short-term accuracy aₛ is measured. When aₛ meets the requirement in the current iteration, the parameters are updated, and the process proceeds to a next iteration. α may be a rate indicating the minimum allowable accuracy after pruning, and β is a rate defining a target execution time in a next pruning iteration.

When lₘ is equal to or longer than lₜ, the next task is selected from R and a next pruning candidate model is created. Once aₛ becomes less than the target accuracy α·aₚ in the current iteration, the current task is removed from R and this task is not considered to be a pruning candidate in the remaining iterations.

When a task that can be pruned any more is not present in R while meeting the accuracy requirement, the process proceeds to the final step. At this step, the final model is trained and tuned, whereby the optimal accuracy and execution time is achieved.

In accordance with an embodiment, it is possible to create a pruning model suitable for a target device, which meets accuracy requirements by utilizing compiler information such as subgraph structures and execution times of a neural network on the target device rather than independently performing deep learning compression and compiler optimization.

Although the embodiments of the present disclosure have been disclosed with reference to the attached drawing, those skilled in the art will appreciate that the present disclosure can be implemented in other concrete forms, without changing the technical spirit or essential features of the disclosure. Therefore, it should be understood that the foregoing embodiments are merely exemplary, rather than restrictive, in all aspects.

What is claimed is:

1. A compiler-based deep learning model pruning method, comprising:
extracting multiple subgraphs from a first deep learning model;
generating programs representing respective tasks allocated to the extracted multiple subgraphs;
compiling the first deep learning model based on selected programs and measuring execution times of tasks of the first deep learning model on respective devices; and
creating a second deep learning model by pruning a subgraph corresponding to at least one task selected from among the tasks from the first deep learning model based on the execution times on the respective devices.

2. The compiler-based deep learning model pruning method of claim 1, wherein generating the programs comprises:
allocating an identical task to two or more subgraphs having an identical form.

3. The compiler-based deep learning model pruning method of claim 1, further comprising:
short-term training the compiled first deep learning model and thereafter measuring accuracy of the first deep learning model; and
determining whether the accuracy of the first deep learning model and an execution time of the first deep learning model meet certain criteria,
wherein, when it is determined that the accuracy of the first deep learning model and the execution time of the first deep learning model meet the certain criteria, proceeding to creating the second deep learning model.

4. The compiler-based deep learning model pruning method of claim 3, wherein:
the first deep learning model is selected from among multiple candidate deep learning models, and
when it is determined that the execution time of the first deep learning model does not meet a certain criterion, the first deep learning model is changed to one of the multiple candidate deep learning models, and thereafter a procedure starting from extracting subgraphs from the changed first deep learning model is performed again.

5. The compiler-based deep learning model pruning method of claim 4, further comprising:
sequentially aligning the tasks based on the execution times between the measuring and creating the second deep learning model.

6. The compiler-based deep learning model pruning method of claim 5, wherein the aligning comprises:
updating a first table in which a program executed at a highest speed for each task, an execution time of the program executed at the highest speed, a number of subgraphs, and a total execution time for each task calculated by multiplying the execution time of the corresponding program by the number of subgraphs are mapped to each task; and
aligning the tasks in descending order based on total execution times for respective tasks and storing the aligned tasks in a task list.

7. The compiler-based deep learning model pruning method of claim 6, further comprising:
updating a second table in which at least one subgraph allocated to each task and a fastest program are mapped to each task, between the aligning and creating the second deep learning model,
wherein the pruning comprises:
creating at least one second deep learning model by pruning a selected subgraph while maintaining a fastest program for an at least one high-ranked task selected from among the aligned tasks.

8. The compiler-based deep learning model pruning method of claim 6, further comprising:
updating the multiple candidate deep learning models to at least one second deep learning model; and
selecting one of updated multiple candidate deep learning models as a first deep learning model, and repeatedly performing again a procedure starting from extracting subgraphs from the first deep learning model,
wherein the procedure is repeatedly performed until the execution time of the first deep learning model meets a certain criterion and a task to be pruned is not present in a previously updated task list.

9. A compiler-based deep learning model pruning apparatus, comprising:
a memory configured to store at least one program; and
a processor configured to execute a first program,
wherein the first program performs:
extracting multiple subgraphs from a first deep learning model;
creating second programs representing respective tasks allocated to the extracted multiple subgraphs;
compiling the first deep learning model based on selected second programs and measuring execution times of tasks of the first deep learning model on respective tasks; and
creating a second deep learning model by pruning a subgraph corresponding to at least task selected from among the tasks from the first deep learning model based on the execution times on the respective devices.

10. The compiler-based deep learning model pruning apparatus of claim 9, wherein, in generating the second programs, the first program allocates an identical task to two or more subgraphs having an identical form.

11. The compiler-based deep learning model pruning apparatus of claim 10, wherein the first program further performs:
short-term training the compiled first deep learning model and thereafter measuring accuracy of the first deep learning model; and
determining whether the accuracy of the first deep learning model and an execution time of the first deep learning model meet certain criteria,
when it is determined that the accuracy of the first deep learning model and the execution time of the first deep learning model meet the certain criteria, the first program performs creating the second deep learning model.

12. The compiler-based deep learning model pruning apparatus of claim 11, wherein:
the first deep learning model is selected from among multiple candidate deep learning models, and
the first program further performs:
when it is determined that the execution time of the first deep learning model does not meet a certain criterion, changing the first deep learning model to one of the multiple candidate deep learning models, and thereafter performing again a procedure starting from extracting subgraphs from the changed first deep learning model.

13. The compiler-based deep learning model pruning apparatus of claim 12, wherein the first program further performs:
sequentially aligning the tasks based on execution times between the measuring and creating the second deep learning model.

14. The compiler-based deep learning model pruning apparatus of claim 13, wherein the first program further performs:
in aligning, updating a first table in which a second program executed at a highest speed for each task, an execution time of the second program executed at the highest speed, a number of subgraphs, and a total execution time for each task calculated by multiplying the execution time of the corresponding second program by the number of subgraphs are mapped to each task; and
aligning the tasks in descending order based on total execution times for respective tasks and then storing the aligned task in a task list.

15. The compiler-based deep learning model pruning apparatus of claim 14, wherein the first program further performs:
updating a second table in which at least one subgraph allocated to each task and a fastest second program are mapped to each task, between the aligning and creating the second deep learning model,
in pruning, the first program creates at least one second deep learning model by pruning a selected subgraph while maintaining a fastest second program for an at least one high-ranked task selected from among the aligned tasks.

16. The compiler-based deep learning model pruning apparatus of claim 15, wherein the second program performs:
updating the multiple candidate deep learning models to at least one second deep learning model; and
selecting one of updated multiple candidate deep learning models as a first deep learning model, and repeatedly performing again a procedure starting from extracting subgraphs from the first deep learning model,
the procedure is repeatedly performed until the execution time of the first deep learning model meets a certain criterion and a task to be pruned is not present in a previously updated task list.

17. A compiler-based deep learning model pruning method, comprising:
extracting multiple subgraphs from a first deep learning model selected from among multiple candidate deep learning models;
generating programs representing respective tasks allocated to the extracted multiple subgraphs;
compiling the first deep learning model based on selected programs and measuring execution times of tasks of the first deep learning model on respective tasks;
short-term training the compiled first deep learning model and thereafter measuring accuracy of the first deep learning model; and
determining whether the accuracy of the first deep learning model and an execution time of the first deep learning model measured in compiling the first deep learning model meet certain criteria;
sequentially aligning the tasks based on the execution times; and
creating at least one second deep learning model by pruning a selected subgraph while maintaining a fastest second program for at least one high-ranked task selected from among the aligned tasks,
wherein the multiple candidate deep learning models are updated to at least one second deep learning model,
wherein one of the updated multiple candidate deep learning models is selected as a first deep learning model, and a procedure starting from extracting subgraphs from the first deep learning model is repeatedly performed again, and
wherein the procedure is repeatedly performed until the execution time of the first deep learning model meets a certain criterion and a task to be pruned is not present.

18. The compiler-based deep learning model pruning method of claim 17, wherein the aligning comprises:
updating a first table in which a program executed at a highest speed for each task, an execution time of the program executed at the highest speed, a number of subgraphs, and a total execution time for each task calculated by multiplying the execution time of the corresponding program by the number of subgraphs are mapped to each task; and
aligning the tasks in descending order based on total execution times for respective tasks and storing the aligned tasks in a task list.

19. The compiler-based deep learning model pruning method of claim 17, further comprising:
updating a second table in which at least one subgraph allocated to each task and a fastest program are mapped to each task, between the aligning and creating the second deep learning model.
